(19) United States
(12) Patent Application Publication
(10) Pub. No.: US 2007/0011456 A1
(43) Pub. Date: Jan. 11, 2007

(54) METHOD AND SYSTEM FOR IDENTIFYING ORIGINAL COPYING SOURCE OF AUDIOVISUAL CONTENT

(75) Inventors: Charles E. Boice, Endicott, NY (US); Thomas J. Fleischman, Poughkeepsie, NY (US)

Correspondence Address: CANTOR COLBURN LLP - IBM FISHKILL, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/160,783

(22) Filed: Jul. 8, 2005

(51) Int. Cl. H04N 7/167; H04L 9/00

(52) U.S. Cl. 713/176

(57) ABSTRACT

A system for identifying an original copying source of audiovisual content includes a recording device configured for receiving input data thereto, means for embedding the user specific information within the input data, the user specific information indicative of the identity of said recording device, and a data storage device within the recording device. The data storage device is configured to store the input data containing the user specific information embedded therein.

### DESCRIPTION

### Background

The present invention relates generally to digital video recording systems, and, more particularly, to a method and system for identifying an original copying source of video content.

Video cassette recorders (VCRs) are a well known technology in which a tape cassette storage medium is used to record and play video content in analog form. The pirating of copyright-protected video programming by repeated copying through the use of VCR devices is generally not a significant concern within the video industry today, since the quality of the analog video signals degrades when copied from one VCR to another.

More recently, digital video recorders (DVRs) have been introduced which are now capable of storing video programs in digital format. A typical DVR receives an input video signal from a source such as an antenna, satellite or cable, for example. Where the source of the input video signal is an analog source, the data is first converted to a digital format (e.g., MPEG-2 compression) by an encoder device before being stored onto an internal hard drive within the DVR unit. The compressed digital data, in addition to being stored, is also typically sent to a decoding device (i.e., converted back to analog format) and thereafter outputted to a device such as a television for viewing. In addition, a customized operating system is commonly included within the DVR, as well as a buffering device for enabling the rewinding and reviewing of portions of a program as it is still being recorded. Some newer DVR devices may even include a digital video disk (DVD) burner included form.

With this newer technology, however, copyright protection has become a more significant concern, since an input video signal in digital format may be reproduced without degradation when copied from one DVR device to another, or from one DVR to another storage medium (such as a DVD). Once stored in a digital format, a user may copy or transmit copyrighted video content digitally (e.g., through a personal computer and over the internet), or can also output the signal through an analog video port (e.g., composite, S-video, component, standard video).

One existing approach with regard to curbing video piracy has been to introduce technology that intentionally degrades the quality of the video signal being shared, thereby attempting to discourage the amount of sharing of digital video files among PCs, DVRs, and over peer-to-peer networks. For example, Macrovision Corporation offers one such product, wherein activation bits instruct an integrated circuit within a playback device to add the protective feature to the outgoing analog video. The content protection is transparent when content is viewed (i.e., not being copied or shared), but prevents or substantially degrades copies made on devices such as DVD recorders, DVRs, PCs, Media Center PCs, D-VHS recorders and VCRs.

Notwithstanding this approach, it would also be desirable to be able to identify the original copying source of pirated video content in the event that existing copy protection measures are themselves bypassed or are unsuccessful in deterring widespread copying.

### SUMMARY

The foregoing discussed drawbacks and deficiencies of the prior art are overcome or alleviated by a system for identifying an original copying source of audiovisual content. In an exemplary embodiment, the system includes a recording device configured for receiving input data thereto, means for embedding the user specific information within the input data, the user specific information indicative of the identity of said recording device, and a data storage device within the recording device. The data storage device is configured to store the input data containing the user specific information embedded therein.

In another embodiment, a method for identifying an original copying source of audiovisual content includes receiving input data at a recording device, embedding user specific information within the input data, the user specific information indicative of the identity of the recording device, and storing the input data containing said user specific information embedded therein.

### BRIEF DESCRIPTION OF THE DRAWINGS

Referring to the exemplary drawings wherein like elements are numbered alike in the several Figures:

FIG. 1 is a block diagram illustrating the basic operation of a digital video recorder (DVR), suitable for use with an embodiment of the invention;

FIG. 2 is a more detailed block diagram of the DVR shown in FIG. 1, particularly illustrating the embedding of user specific information within input video data in order to indicate the identity of the recording device, in accordance with an embodiment of the invention; and

FIG. 3 illustrates exemplary information contained in the user data block of FIG. 2 in further detail.

### DETAILED DESCRIPTION

Disclosed herein is a method and system for identifying an original copying source of video/audio content. Briefly stated, the copying device of video/audio content (e.g., a DVR) is provided with a device that embeds user data (relating to the recording device) within the input signal. Thereby, any recorded data will include the user information such that whenever the copied content is further distributed by unlawful means (e.g., by further transmission to a non-authorized display device) or by the creation of additional unlicensed copies on storage media, the user data from the original recording device is present so as to identify the same. As the embedded data is available in the data stream, it is capable of being read with software, thus extracting the original recording source information.

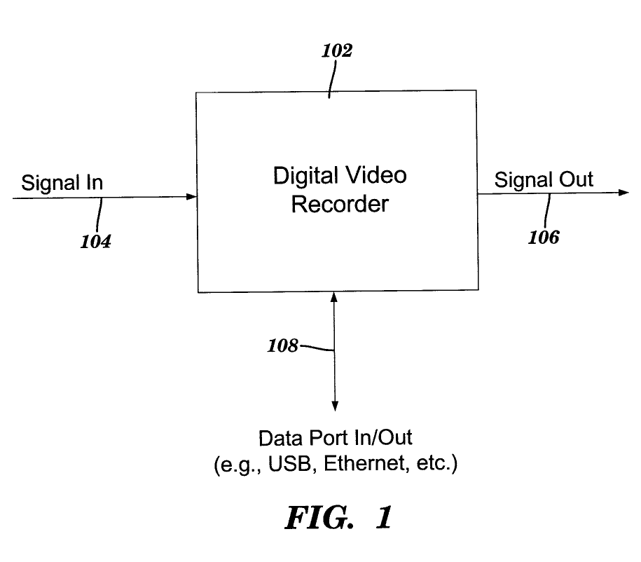

Referring initially to FIG. 1, there is shown block a diagram illustrating the basic operation of a digital video recorder (DVR) 102, suitable for use with an embodiment of the invention. The DVR 102 receives an input video/audio signal 104 from an input source, such as an antenna, cable or satellite, for example. The input video/audio signal 104 may also be formatted in any of a number of existing broadcast formats, such as National Television Standards Committee (NTSC) or PAL broadcast, and digital forms such as Digital Satellite System (DSS), Digital Broadcast Services (DBS), or Advanced Television Standards Committee (ATSC), for example. As discussed in further detail hereinafter, the DVR provides the capability of recording the input data onto a storage medium. An output signal 106 from the DVR 102 is coupled to an output device (such as a television or home theater system, for example) for viewing/listening by a user. The output signal can represent “live television” or, alternatively, the data previously recorded and stored within the DVR 102. In addition, the DVR 102 of FIG. 1 also includes an input/output data port 108 for communication with additional devices, such as a personal computer, for example.

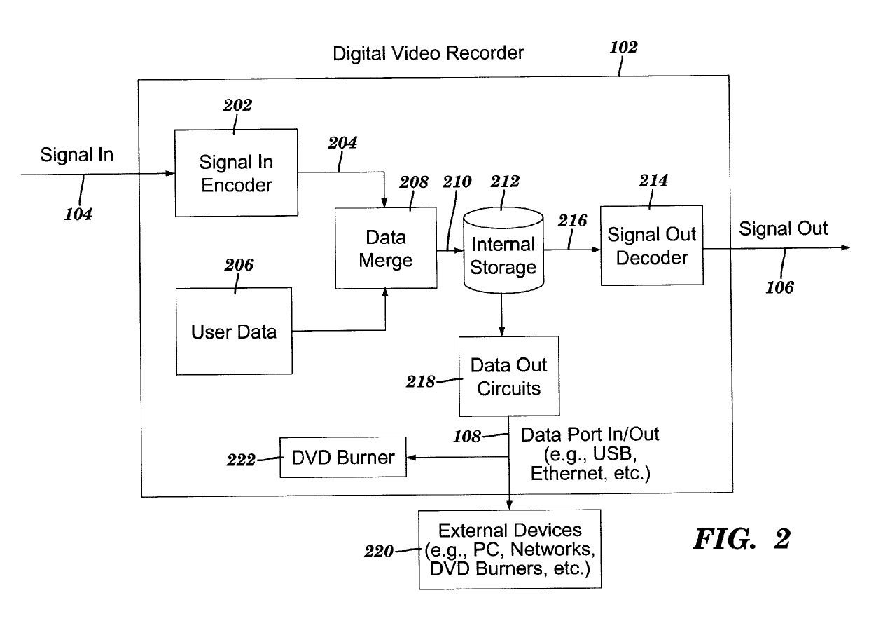

FIG. 2 is a more detailed block diagram of the DVR 102 shown in FIG. 1, particularly illustrating the embedding of user specific information within input video data in order to indicate the identity of the recording device, in accordance with an embodiment of the invention. Depending on the formatting, the input video/audio signal 104 entering the DVR 102 may be in analog form, digital form, or both. For example, DSS, DBS and ASTC are based on MPEG2 and MPEG2 Transport, which is a standard for formatting the digital data stream from the television source transmitter so that a TV receiver can disassemble the input stream to find programs in the multiplexed signal. If the input video/audio signal 104 is not already encoded in such format (e.g., the signal is an analog input), then an encoder 202 is provided within the DVR 102 to encode the input signal 104 into an appropriate digital stream format.

The encoded digital data stream 204 is then merged with user data 206 by a data merge block 208 that embeds the user data 206 (examples of which are discussed hereinafter) within the digital input data stream 204. The data merge block 208 corresponds to a means for embedding user data 206 within digital input data stream 204 (e.g. corresponding to audiovisual content). The means is preferably a circuit, programmed computer or microprocessor device which embeds the user data 206 into data stream 204. The user data 206 is preferably embedded by inserting it into a user defined field enabled by the audiovisual format (e.g. MPEG) generation circuitry. As will be appreciated, the present invention embodiments are particularly useful as applied to a DVR made available in conjunction with a subscription-based service such as TiVo® or ReplayTV®, for example. The merged digital data stream 210 is then input to an internal storage device 212, such as a hard drive, for example. The storage device 212 may be used to record programming content in accordance with a user's preferences, and may also be used as a buffer for automatically recording a currently viewed channel in order to implement various playback features associated with certain subscription-based digital recording devices.

As further illustrated in FIG. 2, a decoder 214 is used to decode the digital data stream output 216 (e.g., MPEG) from the storage device 212. The decoder 214 receives the digital data stream 216 and converts it to an analog output TV signal 106 according to the NTSC, PAL or other applicable TV standards. Alternatively, the output TV signal 106 may be decoded into a digital signal compatible with a digital monitor. In addition, data output circuitry 218 is also included within DVR 102 such that the recorded digital data stream may be outputted via the data input/output port 108 (e.g., USB port, Ethernet, etc.) for communication with other external devices 220 such as personal computers, networking devices, removable media writers (e.g., DVD burners), and the like. The data port 108 could also be used to communicate with additional internal devices, such as a DVD burner 222.

Because the user data 206 is embedded within user fields, it does not adversely impact the decoding process, nor does it affect the quality of the displayed images. Moreover, by embedding the user data prior to storage in the storage device 212, the user data will still be embedded in the encoded data even if outputted through the data port 108. As such, a DVD having copied content from the storage device 212 will also include the user embedded data thereon. Thus, where unauthorized copyrighted content is distributed after having been initially copied via the DVR 102, the user data of the copying DVR 102 will be present within hard copies made from the storage device 212, as well as in transmissions from the storage device 212.

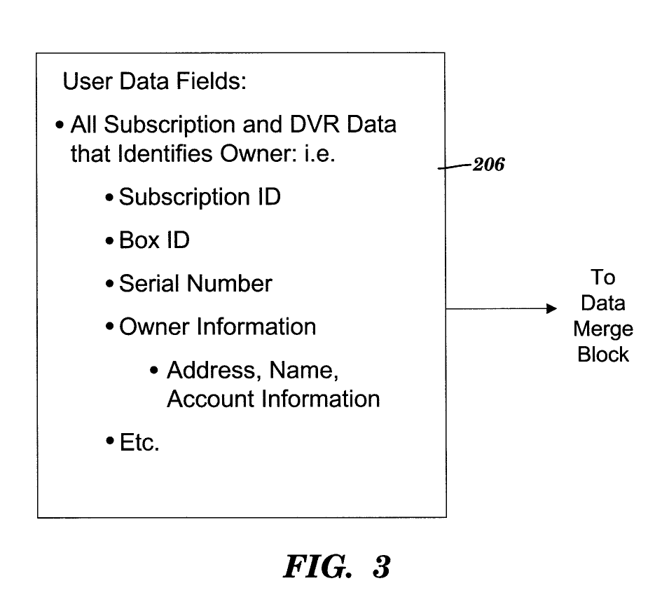

Finally, as more particularly shown in FIG. 3, some specific data fields that may be present within the user data 206 include, but are not limited to: a subscription identification number or account number, a box (device) ID number, a serial number, and various information of the box owner/service subscriber (e.g., name, address, telephone number, e-mail address, or other pertinent account information). Again, this data is embedded within the output stream even where it is transmitted/accessed from the data port 108.

The MPEG standard includes provisions for a user defined field that can be provided with every compressed frame, with the field size being programmable. For example, in MPEG-2, the User_data_start_code 0000001 B2 identifies the beginning of user data, wherein User_data is defined by the users for their specific applications. The above described types of user data would not contain a string of 23 bits or zero bits in order to avoid mimicking a start code for another field. The user specific data may be, but is not required to be, encrypted to prevent tampering. In addition, the data does not need to be included within every frame's user defined field, but can instead be placed at selected frames (to help prevent detection and defeating of the identification feature) or pieces placed sequentially in frames.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for identifying an original copying source of audiovisual content, comprising:
a recording device configured for receiving input data thereto;
means for embedding user specific information within said input data, said user specific information indicative of the identity of said recording device; and
a data storage device within said recording device, said data storage device configured to store said input data containing said user specific information embedded therein.

2. The system of claim 1, wherein said user specific information is included in output data from said recording device.

3. The system of claim 1, wherein said recording device is a digital recording device, and said stored input data is audiovisual data.

4. The system of claim 3, wherein said stored input data is in MPEG format.

5. The system of claim 4, further comprising a decoding device for converting said stored input data into a broadcast format for output to a display device.

6. The system of claim 5, wherein data according to said broadcast format for output to a display device includes said user specific information embedded therein.

7. The system of claim 5, further comprising data out circuitry configured for converting said stored input data to an output format suitable for transmission through a data port.

8. The system of claim 7, wherein data according to said output format suitable for transmission through said data port includes said user specific information embedded therein.

9. The system of claim 8, wherein said data port is coupled to one or more of: a personal computing device, a networking device, an internal removable media writing device, and an external removable media writing device.

10. The system of claim 9, wherein said user specific information includes subscription service based information comprising one or more of: a subscription identification number, a device ID number, a serial number, a subscriber name, a subscriber address, a subscriber telephone number, and a subscriber e-mail address.

11. A method for identifying an original copying source of audiovisual content, the method comprising:
receiving input data at a recording device;
embedding user specific information within said input data, said user specific information indicative of the identity of said recording device; and
storing said input data containing said user specific information embedded therein.

12. The method of claim 11, wherein said user specific information is included in output data from said recording device.

13. The method of claim 11, wherein said recording device is a digital recording device, and said stored input data is audiovisual data.

14. The method of claim 13, wherein said stored input data is in MPEG format.

15. The method of claim 14, further decoding said stored input data into a broadcast format for output to a display device.

16. The method of claim 15, wherein data according to said broadcast format for output to a display device includes said user specific information embedded therein.

17. The method of claim 15, further comprising converting said stored input data to an output format suitable for transmission through a data port.

18. The method of claim 17, wherein data according to said output format suitable for transmission through said data port includes said user specific information embedded therein which can be extracted for user identification.

19. The method of claim 8, wherein said data port is coupled to one or more of: a personal computing device, a networking device, an internal removable media writing device, and an external removable media writing device.

20. The method of claim 13, wherein said user specific information includes subscription service based information comprising one or more of: a subscription identification number, a device ID number, a serial number, a subscriber name, a subscriber address, a subscriber telephone number, and a subscriber e-mail address.
